(19) United States
(12) Patent Application Publication
(10) Pub. No.: US 2026/0326845 A1
(43) Pub. Date: Oct. 22, 2026

(54) MOBILE ASSEMBLY AND MOBILE ASSEMBLY SYSTEM

(71) Applicant: Addverb Technologies Limited, Noida (IN)

(72) Inventors: K. V. N. B. Sai KRISHNA MOHAN, Guntur (IN); Binay Kumar Sharma, Greater Noida (IN); Monel Mukesh Solani, Greater Noida (IN); Sylvain Gerard Bernard Aurvay, Greater Noida (IN)

(73) Assignee: Addverb Technologies Limited, Noida (IN)

(21) Appl. No.: 19/468,339

(22) Filed: Feb. 3, 2026

(30) Foreign Application Priority Data
Feb. 4, 2025 (IN) 202511009031
Feb. 12, 2025 (IN) 202511012091
Jan. 30, 2026 (IN) 202611010205

(51) Int. Cl. B62D 65/18; B25B 5/14

(52) U.S. Cl. CPC B62D 65/18; B25B 5/14

(57) ABSTRACT

A mobile assembly and a mobile assembly system are described, comprising a platform, a clamping assembly mounted on the platform, and a lifting assembly mounted on the platform. The clamping assembly is configured to adapt to different workpiece dimensions while providing controlled clamping force. The lifting assembly is configured to provide vertical positioning of a workpiece secured by the clamping assembly. In some embodiments, a controller is operatively coupled to the clamping assembly and the lifting assembly, and is configured to verify that the clamping force has reached a predetermined threshold and the clamping assembly is within a predetermined position range before initiating vertical displacement via the lifting assembly, and maintain the clamping parameters during vertical displacement operations.

### FIELD OF THE PRESENT DISCLOSURE

The present disclosure relates generally to the field of automated assembly systems and material handling equipment. More particularly, the present disclosure pertains to a mobile assembly and a mobile assembly system incorporating integrated clamping and lifting functionalities for coordinated workpiece handling during assembly operations.

### BACKGROUND

In modern manufacturing and assembly operations, automated systems are extensively used for handling, securing, and positioning various workpieces during processing. These automated systems require reliable mechanisms to ensure proper securing of workpieces and precise positioning during various operations. The secure holding of workpieces combined with controlled vertical positioning is required to maintain quality and efficiency in manufacturing processes, as inadequate securing during lifting operations can lead to workpiece slippage, misalignment, damage to components, or safety hazards for personnel. Assembly operations, particularly those involving vehicles and large assemblies, often require both clamping capabilities to secure the workpiece and lifting capabilities to position the workpiece at appropriate heights for different stages of assembly.

A significant challenge in implementing automated assembly systems is the coordination between clamping operations and lifting operations. When a workpiece is lifted without adequate securing, the workpiece may shift or fall during vertical displacement, resulting in damage to the workpiece, damage to equipment, or injury to personnel. Conversely, releasing clamping force during lifting operations can lead to similar problems. The need to verify that a workpiece is securely clamped before initiating vertical displacement, and the need to maintain clamping force throughout lifting operations, presents significant engineering challenges in automated assembly environments. Additionally, the inability to coordinate these operations through a unified control system limits the efficiency and reliability of conventional assembly processes.

Conventional solutions to these challenges typically employ separate clamping systems and lifting systems that operate independently. In such conventional arrangements, operators must manually coordinate the sequence of operations, first engaging the clamping mechanism and then activating the lifting mechanism. This manual coordination is time-consuming and prone to human error, as operators may inadvertently initiate lifting before adequate clamping force is achieved. Some conventional systems employ basic interlock switches that prevent lifting motor activation until a clamping position sensor indicates engagement, but such systems lack the ability to verify actual clamping force or to continuously monitor clamping conditions during lifting operations.

While the conventional solutions mentioned above may provide some operational capability, they often fall short in achieving consistent performance required for automated assembly systems. Separate clamping and lifting systems require dedicated mounting structures and control interfaces, increasing complexity and cost. The lack of integrated control prevents optimization of the clamping and lifting sequence based on workpiece characteristics. Furthermore, conventional systems typically cannot adapt clamping parameters based on workpiece dimensions or continuously monitor both clamping force and vertical position during operations to detect anomalies that may indicate unsafe conditions. The absence of coordinated control also prevents implementation of sequential operation protocols that ensure workpiece security throughout the assembly process.

Therefore, there exists a need for a mobile assembly and a mobile assembly system that integrates clamping and lifting functionalities on a common platform with coordinated control. Such a solution should provide verification of clamping force before initiating vertical displacement, maintain clamping force during lifting operations, and enable continuous monitoring of both clamping and lifting parameters to detect anomalies. The solution should further enable implementation of sequential operation protocols that ensure workpiece security throughout assembly processes while adapting to different workpiece dimensions and assembly requirements.

### SUMMARY

In an aspect, the present disclosure provides a mobile assembly comprising a platform, a clamping assembly mounted on the platform, and a lifting assembly mounted on the platform. The clamping assembly is configured to adapt to different workpiece dimensions while providing controlled clamping force. The lifting assembly is configured to provide vertical positioning of a workpiece secured by the clamping assembly.

In some embodiments, the clamping assembly comprises a support frame and first and second movable plates mounted on the support frame.

In some embodiments, the clamping assembly further comprises a drive mechanism coupled to the first and second movable plates, wherein the drive mechanism is configured to move the first and second movable plates in a synchronized and self-centering manner.

In some embodiments, the clamping assembly further comprises a guide shaft mounted parallel to a lead screw shaft of the drive mechanism, and guide elements coupled to the first and second movable plates and slidably engaged with the guide shaft to prevent rotation of the first and second movable plates.

In some embodiments, the clamping assembly further comprises at least one sensor configured to monitor at least one parameter indicative of the clamping force applied by the first and second movable plates.

In some embodiments, the clamping assembly further comprises at least one proximity sensor configured to detect presence of an object within a predetermined clearance zone adjacent to the first and second movable plates during movement thereof.

In some embodiments, the clamping assembly further comprises a motor coupled to the drive mechanism, and a quick-release mechanism configured to enable transition between powered operation via the motor and manual operation.

In some embodiments, the lifting assembly comprises a base structure, at least one lifting platform arranged on the base structure, the at least one lifting platform comprising a scissor mechanism having a lower end pivotally mounted to the base structure and an upper end supporting a platform surface, and at least one linear motion guide rail arranged vertically on the base structure to provide guidance for vertical movement of the scissor mechanism.

In some embodiments, the lifting assembly further comprises a cam mechanism comprising a rotatable cam and at least one cam follower, wherein the at least one cam follower engages with the rotatable cam and is coupled to a central portion of the scissor mechanism, and a drive assembly configured to rotate the cam mechanism to move the scissor mechanism between a fully retracted position and a fully extended position.

In some embodiments, the lifting assembly comprises a first lifting platform and a second lifting platform, and the drive assembly is operatively coupled to both the first lifting platform and the second lifting platform to provide synchronized vertical movement.

In another aspect, the present disclosure provides a mobile assembly system comprising a platform, a clamping assembly mounted on the platform, a lifting assembly mounted on the platform, and a controller operatively coupled to the clamping assembly and the lifting assembly. The clamping assembly is configured to adapt to different workpiece dimensions while providing controlled clamping force. The lifting assembly is configured to provide vertical positioning. The controller is configured to verify clamping force provided by the clamping assembly before initiating vertical displacement via the lifting assembly, and maintain the clamping force during vertical displacement operations.

In some embodiments, the controller is further configured to receive dimensional data associated with a workpiece, adjust the clamping assembly based on the dimensional data, and control vertical positioning of the workpiece via the lifting assembly based on assembly operation requirements.

In some embodiments, the controller is further configured to prevent the lifting assembly from initiating vertical displacement until the clamping force provided by the clamping assembly reaches a predetermined threshold value.

In some embodiments, the controller is further configured to execute a sequential operation protocol comprising positioning a workpiece relative to the clamping assembly, initiating a clamping operation via the clamping assembly, verifying that the clamping force has reached a predetermined threshold and the clamping assembly is within a predetermined position range, and initiating vertical displacement via the lifting assembly only upon successful verification.

In some embodiments, the controller is further configured to continuously monitor the clamping operation of the clamping assembly and a vertical position parameter from the lifting assembly during operations, and halt operations of both the clamping assembly and the lifting assembly upon detecting an anomaly therein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present disclosure, reference is now made to the following descriptions taken in connection with the accompanying drawings in which:

FIG. 1A illustrates a perspective view of a mobile assembly from a first side, showing a clamping assembly and a lifting assembly mounted on a platform, in accordance with one or more embodiments of the present disclosure;

FIG. 1B illustrates a perspective view of the mobile assembly from a second side, in accordance with one or more embodiments of the present disclosure;

FIG. 1C illustrates a side elevational view of the mobile assembly from a first side, in accordance with one or more embodiments of the present disclosure;

FIG. 1D illustrates a side elevational view of the mobile assembly from a second side, in accordance with one or more embodiments of the present disclosure;

FIG. 1E illustrates a front elevational view of the mobile assembly, in accordance with one or more embodiments of the present disclosure;

FIG. 1F illustrates a rear elevational view of the mobile assembly, in accordance with one or more embodiments of the present disclosure;

FIG. 2A illustrates a perspective view of the clamping assembly mounted on a portion of the platform, in accordance with one or more embodiments of the present disclosure;

FIG. 2B illustrates a perspective view of the clamping assembly showing internal components thereof, in accordance with one or more embodiments of the present disclosure;

FIG. 3A illustrates a detailed view of a first movable plate of the clamping assembly, in accordance with one or more embodiments of the present disclosure;

FIG. 3B illustrates a detailed view of a second movable plate of the clamping assembly, in accordance with one or more embodiments of the present disclosure;

FIG. 4 illustrates a detailed view of a clamping pad configured to be mounted on the movable plates, in accordance with one or more embodiments of the present disclosure;

FIG. 5 illustrates a detailed view of a fixed plate of the clamping assembly, in accordance with one or more embodiments of the present disclosure;

FIG. 6 illustrates a detailed view of a lead screw shaft of a drive mechanism of the clamping assembly, in accordance with one or more embodiments of the present disclosure;

FIG. 7 illustrates a detailed view of a guide shaft of the clamping assembly, in accordance with one or more embodiments of the present disclosure;

FIG. 8A illustrates a detailed view of a motor and a gearbox assembly coupled to the lead screw shaft, in accordance with one or more embodiments of the present disclosure;

FIG. 8B illustrates a detailed view of a timing pulley of the clamping assembly, in accordance with one or more embodiments of the present disclosure;

FIG. 8C illustrates a detailed view of a timing belt of the clamping assembly, in accordance with one or more embodiments of the present disclosure;

FIG. 9 illustrates a perspective view of the clamping assembly showing a quick-release mechanism and a manual operation mechanism, in accordance with one or more embodiments of the present disclosure;

FIG. 10A illustrates an isometric view of the lifting assembly showing a first lifting platform and a second lifting platform with platform surfaces, in accordance with one or more embodiments of the present disclosure;

FIG. 10B illustrates a side elevational view of the lifting assembly showing a drive assembly connecting both lifting platforms through a drive shaft, in accordance with one or more embodiments of the present disclosure;

FIG. 10C illustrates a front elevational view of the lifting assembly showing a scissor mechanism for one of the lifting platforms in a fully retracted position, in accordance with one or more embodiments of the present disclosure;

FIG. 11A illustrates a detailed isometric view of one lifting platform of the lifting assembly from a first side along with the drive assembly, showing integration of the scissor mechanism with linear motion guide rails, in accordance with one or more embodiments of the present disclosure;

FIG. 11B illustrates an exploded isometric view of the lifting platform of FIG. 11A from a second side, showing assembly details of the scissor mechanism and the cam mechanism, in accordance with one or more embodiments of the present disclosure;

FIG. 11C illustrates an isometric view of the lifting platform of FIG. 11A from the first side, showing the scissor mechanism in a partially extended position, in accordance with one or more embodiments of the present disclosure;

FIG. 11D illustrates an isometric view of the lifting platform of FIG. 11A from the second side, showing the scissor mechanism in the partially extended position, in accordance with one or more embodiments of the present disclosure;

FIG. 11E illustrates a planar view of the lifting platform of FIG. 11A showing the scissor mechanism in the partially extended position, in accordance with one or more embodiments of the present disclosure;

FIG. 12 illustrates a schematic block diagram of a controller of a mobile assembly system showing operative coupling to the clamping assembly and the lifting assembly, in accordance with one or more embodiments of the present disclosure; and

FIG. 13 illustrates a flowchart of a sequential operation protocol executed by the controller for coordinated operation of the clamping assembly and the lifting assembly, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Aspects of this disclosure are directed to a mobile assembly and a mobile assembly system, specifically designed to be implemented for manufacturing, assembly operations, material handling, and various automated systems requiring coordinated clamping and vertical positioning of workpieces. The mobile assembly integrates a clamping assembly and a lifting assembly on a common platform, enabling a workpiece to be secured by the clamping assembly and then vertically positioned by the lifting assembly while maintaining the clamping force. The mobile assembly system further incorporates a controller that coordinates operation of the clamping assembly and the lifting assembly, verifying that clamping operation is successful, i.e., the clamping force has reached a predetermined threshold and the clamping assembly is within a predetermined position range before initiating vertical displacement and maintaining proper clamping during vertical displacement operations. The mobile assembly and the mobile assembly system of the present disclosure are particularly suited for assembly line applications where workpieces of varying dimensions must be securely held and precisely positioned at different heights during various stages of assembly.

For purposes of this disclosure, the term “mobile assembly” refers to a mechanical assembly configured to be moved along operational paths and comprising integrated clamping and lifting functionalities for workpiece handling. The term “clamping assembly” as used herein refers to a mechanical assembly configured to secure a workpiece by applying controlled clamping force through movable plates that move in a synchronized manner. The term “lifting assembly” as used herein refers to a mechanical assembly configured to provide vertical positioning of a supported workpiece through actuation of a scissor mechanism. The term “controller” as used herein refers to an electronic device configured to receive input signals, process data, and generate output signals to coordinate operation of the clamping assembly and the lifting assembly.

The mobile assembly of the present disclosure achieves operational capabilities through integration of the clamping assembly and the lifting assembly on a common platform, wherein a workpiece positioned on the lifting assembly can be secured by the clamping assembly before the lifting assembly provides vertical positioning. This integration enables the clamping assembly to adapt to different workpiece dimensions while providing controlled clamping force, and enables the lifting assembly to provide vertical positioning of the workpiece while the clamping assembly maintains the clamping force. The mobile assembly system of the present disclosure further incorporates the controller that verifies clamping force and the clamping plates positions before initiating vertical displacement and maintains clamping force during vertical displacement operations, ensuring that the workpiece remains securely held throughout assembly processes.

For purposes of illustration and without limiting the scope of the present disclosure, exemplary embodiments are described herein with reference to implementation of the mobile assembly in an automated assembly line for vehicle assembly operations. However, it should be understood that the mobile assembly and the mobile assembly system may be implemented in various other applications and configurations. The mobile assembly and the mobile assembly system may be employed in manufacturing facilities, warehouses, distribution centers, or other environments requiring coordinated clamping and lifting of workpieces. Further, while specific embodiments describe clamping of wheels or tires, the clamping assembly may be configured to clamp various types of workpieces based on specific application requirements.

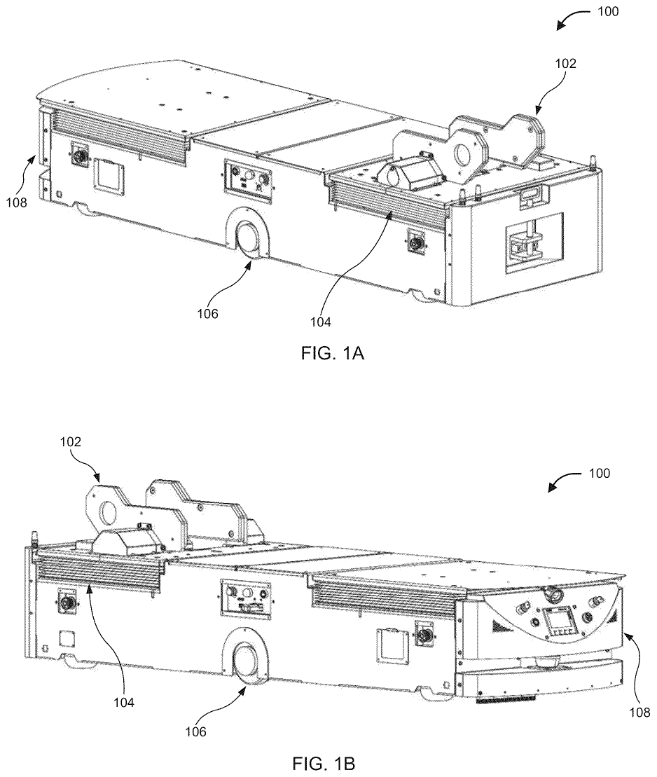

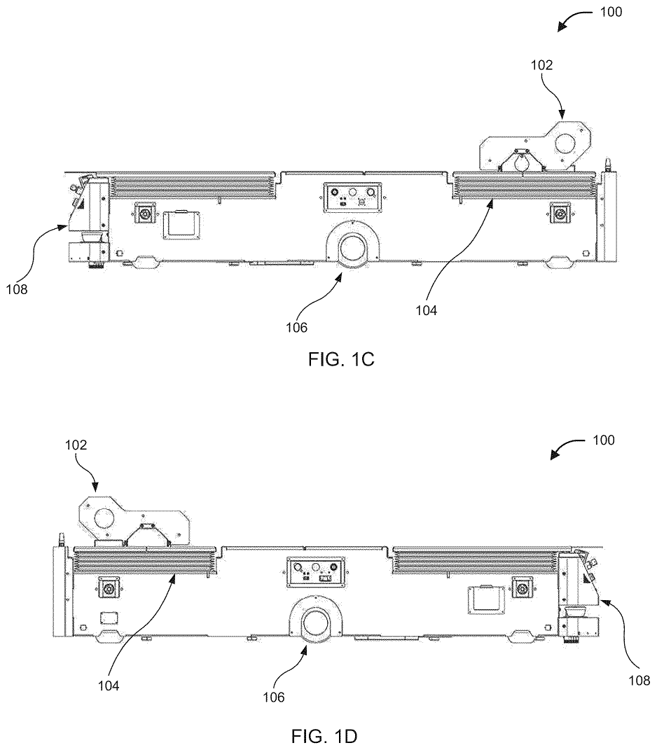

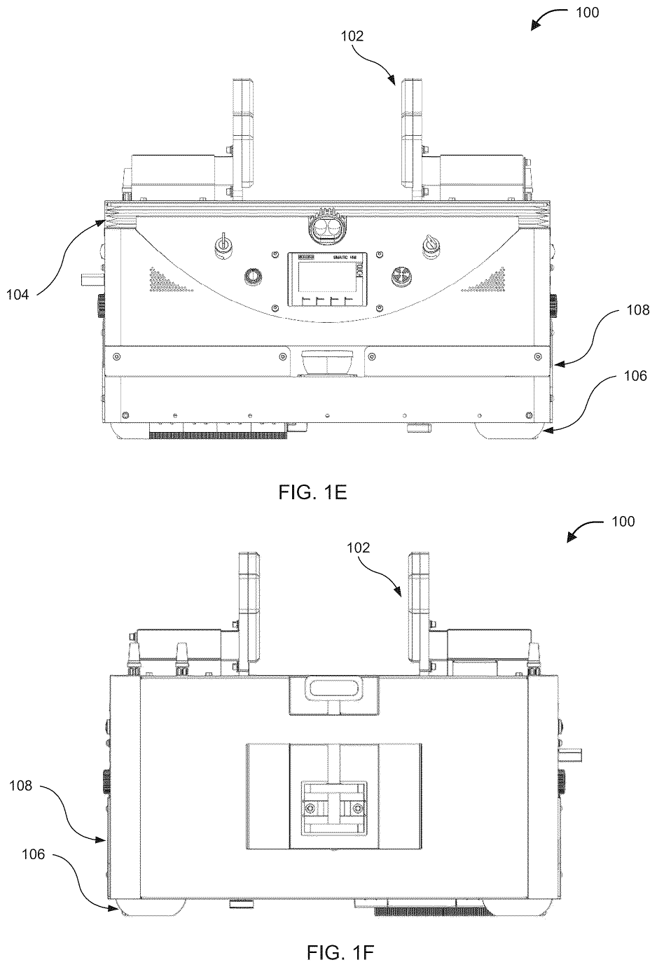

Referring to FIGS. 1A to 1F in combination, illustrated is a mobile assembly (represented by reference numeral 100), in accordance with one or more embodiments of the present disclosure. The mobile assembly 100 is configured for automated operations involving securing and vertical positioning of workpieces during assembly processes. The mobile assembly 100 integrates a clamping assembly 102 and a lifting assembly 104, enabling coordinated operation of both assemblies for handling workpieces throughout various stages of assembly or other similar operations. The mobile assembly 100 is configured to move along operational paths within an assembly environment, with wheels 106 enabling movement of the mobile assembly 100 between different stations along an assembly line.

As illustrated in FIGS. 1A to 1F, the mobile assembly 100 comprises a platform 108. The platform 108 provides a structural foundation for supporting the clamping assembly 102 and the lifting assembly 104. The platform 108 is configured to maintain alignment between the clamping assembly 102 and the lifting assembly 104 during operation, ensuring that a workpiece secured by the clamping assembly 102 is properly positioned relative to the lifting assembly 104 for vertical positioning operations. The platform 108 includes mounting regions for the clamping assembly 102 and the lifting assembly 104, with the mounting regions arranged such that a workpiece can be simultaneously engaged by both assemblies during operation.

Herein, the clamping assembly 102 is configured to adapt to different workpiece dimensions while providing controlled clamping force. As used herein, “adapt to different workpiece dimensions” refers to the capability of the clamping assembly 102 to adjust the spacing between clamping elements to accommodate workpieces of varying sizes without requiring manual reconfiguration or replacement of components. The clamping assembly 102 provides controlled clamping force to secure a workpiece in position relative to the lifting assembly 104, preventing movement or slippage of the workpiece during vertical displacement operations performed by the lifting assembly 104.

The clamping assembly 102 is mounted on the platform 108 in a position that enables the clamping assembly 102 to engage workpieces positioned on the lifting assembly 104. In the illustrated embodiment, the clamping assembly 102 is positioned such that clamping elements of the clamping assembly 102 can engage opposite sides of a workpiece, such as a wheel or tire of a vehicle, to secure the workpiece between the clamping elements. The mounting position of the clamping assembly 102 on the platform 108 is selected to enable engagement with workpieces at various heights as the lifting assembly 104 moves between a fully retracted position and a fully extended position.

Further, the lifting assembly 104 is configured to provide vertical positioning of a workpiece secured by the clamping assembly 102. As used herein, “vertical positioning” refers to controlled movement of the workpiece in a direction perpendicular to the platform 108, enabling the workpiece to be raised or lowered to different heights as required for various stages of assembly operations. The lifting assembly 104 is configured to support the weight of the workpiece during vertical displacement while the clamping assembly 102 maintains clamping force to prevent lateral movement of the workpiece.

The lifting assembly 104 is mounted on the platform 108 in a position that enables the lifting assembly 104 to support workpieces that are simultaneously engaged by the clamping assembly 102. In the illustrated embodiment, the lifting assembly 104 comprises lifting platforms that support a workpiece from below while the clamping assembly 102 engages the workpiece from the sides. This arrangement enables the workpiece to be securely held by the clamping assembly 102 during vertical displacement provided by the lifting assembly 104, preventing the workpiece from shifting or falling during lifting operations.

The integration of the clamping assembly 102 and the lifting assembly 104 on the common platform 108 enables coordinated operation of both assemblies for workpiece handling. A workpiece placed on the lifting assembly 104 can be engaged by the clamping assembly 102 to secure the workpiece in position, and then the lifting assembly 104 can provide vertical positioning of the workpiece while the clamping assembly 102 maintains clamping force. This coordinated operation ensures that the workpiece remains securely held throughout vertical displacement, preventing slippage or movement that could result in damage to the workpiece or injury to personnel.

The mobile assembly 100 incorporates the wheels 106 that enable movement of the mobile assembly 100 along operational paths. The wheels 106 are mounted to the platform 108 and are configured to support the weight of the mobile assembly 100 along with any workpiece secured thereon. In configurations where the mobile assembly 100 is implemented in an assembly line, the wheels 106 may engage with guide tracks or rails that define the operational path of the mobile assembly 100 between different assembly stations. In other configurations, the wheels 106 may be guided through a guided system using bar codes or RFID tags or position markers from the induction charging line, without any limitations.

In operation, the mobile assembly 100 moves along an assembly line and stops at positions where a workpiece is to be loaded onto the lifting assembly 104. The clamping assembly 102 is then operated to engage and secure the workpiece, adapting to the dimensions of the workpiece while providing controlled clamping force. Once the workpiece is secured, the lifting assembly 104 can be operated to provide vertical positioning of the workpiece as required for assembly operations. Throughout the vertical displacement operation, the clamping assembly 102 maintains clamping force to ensure the workpiece remains securely held. Upon completion of assembly operations at a particular station, the mobile assembly 100 moves to the next station along the assembly line, with the workpiece remaining secured by the clamping assembly 102 during movement.

In some embodiments, the mobile assembly 100 may further comprise a trolley (not shown) connected to a rear end of the platform 108. The trolley is configured to carry parts for assembly operations, following movement of the mobile assembly 100 along the assembly line. The trolley enables assembly personnel to have access to parts required for assembly operations without requiring separate transport of parts to each assembly station.

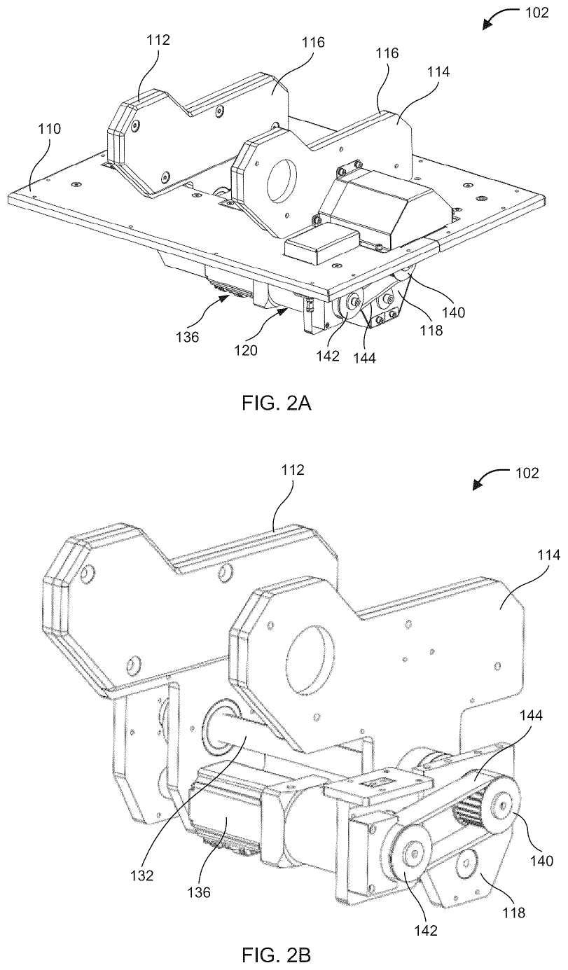

Referring now to FIGS. 2A and 2B in combination, illustrated is the clamping assembly 102 of the mobile assembly 100, in accordance with one or more embodiments of the present disclosure. The clamping assembly 102 is configured to adapt to different workpiece dimensions while providing controlled clamping force to secure workpieces during assembly operations. The clamping assembly 102 comprises components that enable synchronized movement of clamping elements to engage workpieces of varying sizes, and components that enable monitoring and control of the clamping force applied to workpieces.

As illustrated, the clamping assembly 102 comprises a support frame 110. The support frame 110 provides a structural foundation for the clamping assembly 102 and provides mounting points for other components of the clamping assembly 102. The support frame 110 is configured to be mounted on the platform 108 of the mobile assembly 100 and to maintain alignment of components of the clamping assembly 102 during operation. The support frame 110 is formed as a rigid structure capable of withstanding forces generated during clamping operations without deformation that would affect alignment of the clamping elements.

The clamping assembly 102 further comprises a first movable plate 112 and a second movable plate 114 mounted on the support frame 110. The first movable plate 112 and the second movable plate 114 are configured to move toward each other to engage and clamp a workpiece therebetween, and to move away from each other to release the workpiece. In the illustrated embodiment, the first movable plate 112 and the second movable plate 114 are arranged on opposite sides of a clamping region, with the clamping region defined as the space between the first movable plate 112 and the second movable plate 114 where a workpiece is positioned for clamping.

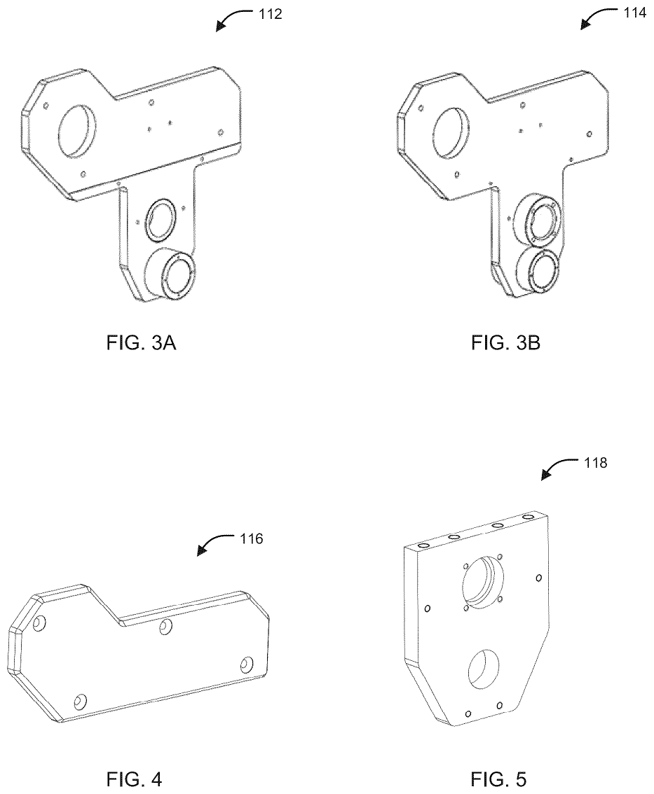

Referring to FIGS. 3A and 3B, illustrated are detailed views of the first movable plate 112 and the second movable plate 114, respectively. Each of the first movable plate 112 and the second movable plate 114 is formed as a rigid member having a configuration suitable for engaging a workpiece surface. The first movable plate 112 and the second movable plate 114 include mounting features for attachment of clamping pads 116 (as better illustrated in FIG. 4) on surfaces thereof that face the clamping region. The first movable plate 112 and the second movable plate 114 further include features for engagement with drive mechanism components and guide components, as described in further detail below.

Referring to FIG. 4, illustrated is the clamping pad 116 configured to be mounted on the first movable plate 112 or the second movable plate 114. The clamping pad 116 comprises a resilient material configured to conform to a surface of a workpiece being clamped. The resilient material of the clamping pad 116 provides cushioning that prevents damage to the workpiece surface during clamping operations and provides friction that prevents slippage of the workpiece relative to the first movable plate 112 and the second movable plate 114 during lifting operations. In some embodiments, the clamping pad 116 may comprise rubber, polymer, or other resilient material selected based on characteristics of workpieces to be clamped.

Referring to FIG. 5, illustrated is a fixed plate 118 of the clamping assembly 102. The fixed plate 118 is mounted to the support frame 110 and provides support for components of a drive mechanism 120 (as illustrated in FIG. 2A) of the clamping assembly 102. The fixed plate 118 includes apertures and mounting features for bearing assemblies, the lead screw shaft, the guide shaft, and other components of the drive mechanism 120.

The clamping assembly 102 further comprises the drive mechanism 120 coupled to the first movable plate 112 and the second movable plate 114. The drive mechanism 120 is configured to move the first movable plate 112 and the second movable plate 114 in a synchronized and self-centering manner. As used herein, “synchronized” refers to the first movable plate 112 and the second movable plate 114 moving simultaneously at equal speeds in opposite directions, such that the total travel distance of the first movable plate 112 equals the total travel distance of the second movable plate 114 during any clamping or release operation. As used herein, “self-centering” refers to the characteristic that a workpiece engaged by the first movable plate 112 and the second movable plate 114 is automatically positioned at the center of the clamping region regardless of the initial position of the workpiece within the clamping region.

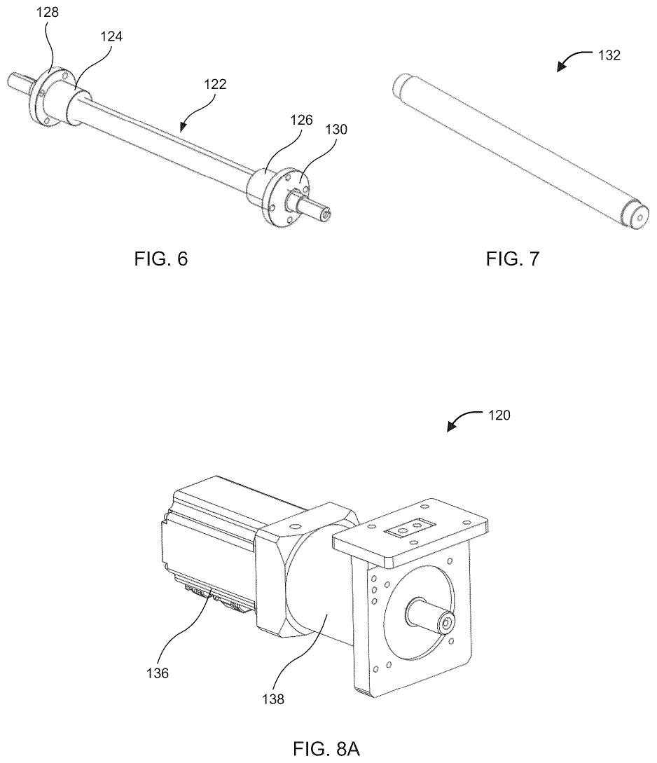

Referring to FIG. 6, illustrated is a lead screw shaft 122 of the drive mechanism 120. In some embodiments, the lead screw shaft 122 comprises a first portion 124 with right-hand threads and a second portion 126 with left-hand threads. A first threaded nut 128 is coupled to the first movable plate 112 and engaged with the right-hand threads of the first portion 124. A second threaded nut 130 is coupled to the second movable plate 114 and engaged with the left-hand threads of the second portion 126. Rotation of the lead screw shaft 122 causes the first threaded nut 128 and the second threaded nut 130 to move in opposite directions along the lead screw shaft 122, thereby causing synchronized movement of the first movable plate 112 and the second movable plate 114 in opposite directions.

The self-centering characteristic of the drive mechanism 120 is achieved through the configuration of the first portion 124 with right-hand threads and the second portion 126 with left-hand threads on the lead screw shaft 122. When the lead screw shaft 122 is rotated in a first direction, the first movable plate 112 and the second movable plate 114 move toward each other at equal speeds, engaging a workpiece and centering the workpiece at the midpoint between the first movable plate 112 and the second movable plate 114. When the lead screw shaft 122 is rotated in a second direction opposite to the first direction, the first movable plate 112 and the second movable plate 114 move away from each other at equal speeds to release the workpiece.

Referring to FIG. 7, illustrated is a guide shaft 132 of the clamping assembly 102. The clamping assembly 102 includes the guide shaft 132 mounted parallel to the lead screw shaft 122. Guide elements (not shown) are coupled to the first movable plate 112 and the second movable plate 114 and are slidably engaged with the guide shaft 132 to prevent rotation of the first movable plate 112 and the second movable plate 114. The guide shaft 132 and the guide elements maintain linear alignment of the first movable plate 112 and the second movable plate 114 during movement, preventing the first movable plate 112 and the second movable plate 114 from rotating about the lead screw shaft 122 as the lead screw shaft 122 is rotated.

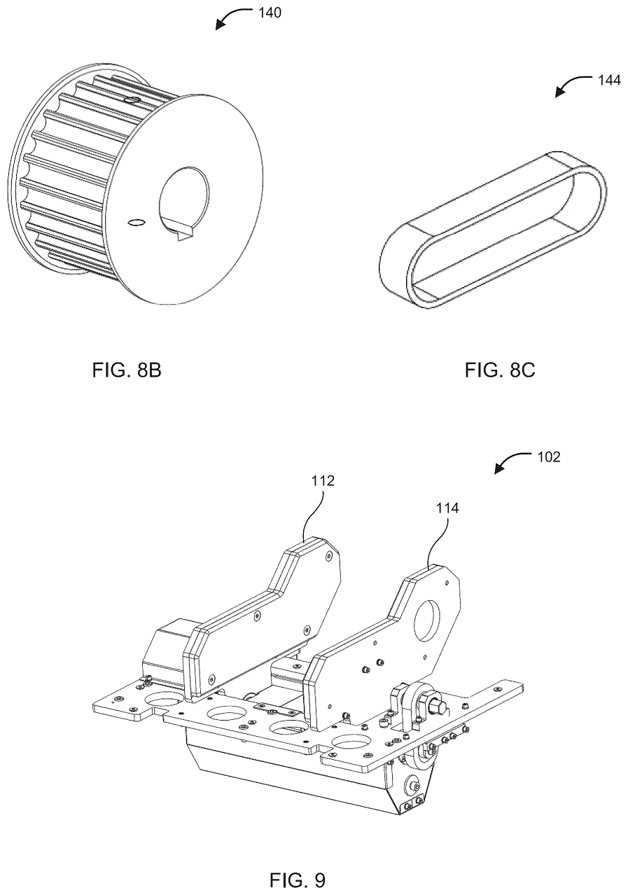

Referring to FIGS. 8A to 8C in combination, illustrated are components of the drive mechanism 120 for rotating the lead screw shaft 122. The clamping assembly 102 comprises a motor 136 coupled to the drive mechanism 120. The motor 136 is configured to provide rotational motion for driving the lead screw shaft 122. As shown in the illustrated embodiment, the motor 136 is coupled to a gearbox 138 that provides speed reduction and torque multiplication between the motor 136 and the lead screw shaft 122. A timing pulley 140 (as illustrated in FIG. 8B) is mounted on the lead screw shaft 122, a drive pulley 142 is mounted on an output shaft of the gearbox 138, and a timing belt 144 (as illustrated in FIG. 8C) couples the timing pulley 140 to the drive pulley 142 to transfer rotational motion from the motor 136 to the lead screw shaft 122.

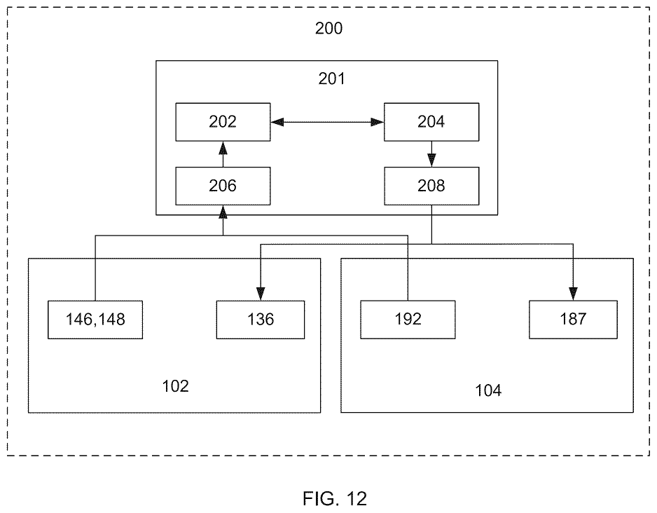

The clamping assembly 102 further comprises at least one sensor configured to monitor operational parameters including a position of the first movable plate 112 and the second movable plate 114 (better depicted in FIG. 9) and the clamping force applied thereby. In some embodiments, the at least one sensor 146 (illustrated in FIG. 12) comprises a current sensor configured to monitor current drawn by the motor 136 during clamping operations, and a position sensor configured to monitor the linear position of the first movable plate 112 and the second movable plate 114. The current drawn by the motor 136 increases as the first movable plate 112 and the second movable plate 114 engage a workpiece and the clamping force increases, providing an indirect measurement of the clamping force. The position sensor, which may be an encoder integrated with the motor 136 or an external linear sensor, provides position data to verify that the first movable plate 112 and the second movable plate 114 are within a predetermined clamping range. In other embodiments, the at least one sensor 146 may comprise force sensors, strain gauges, or other sensors configured to directly or indirectly measure the clamping force, without any limitations.

The clamping assembly 102 may further comprise at least one proximity sensor 148 (illustrated in FIG. 12) configured to detect presence of an object within a predetermined clearance zone adjacent to the first movable plate 112 and the second movable plate 114 during movement thereof. The at least one proximity sensor 148 provides a safety function to prevent injury to personnel who may be positioned near the clamping assembly 102 during operation. When the at least one proximity sensor 148 detects presence of an object within the predetermined clearance zone, the clamping assembly 102 can be stopped or slowed to prevent pinch-point hazards that may occur as the first movable plate 112 and the second movable plate 114 move toward each other.

In some embodiments, the clamping assembly 102 may further include a quick-release mechanism configured to enable transition between powered operation via the motor 136 and manual operation. The quick-release mechanism enables disengagement of the motor 136 from the lead screw shaft 122, permitting manual rotation of the lead screw shaft 122 when powered operation is not available or not desired. In the illustrated embodiment, the quick-release mechanism may include a mounting bracket (not shown) for the motor 136, a tensioning bolt (not shown), and a spring element (not shown) which is configured to maintain tension on the timing belt 144 during powered operation and to release tension via adjustment of the tensioning bolt for manual operation.

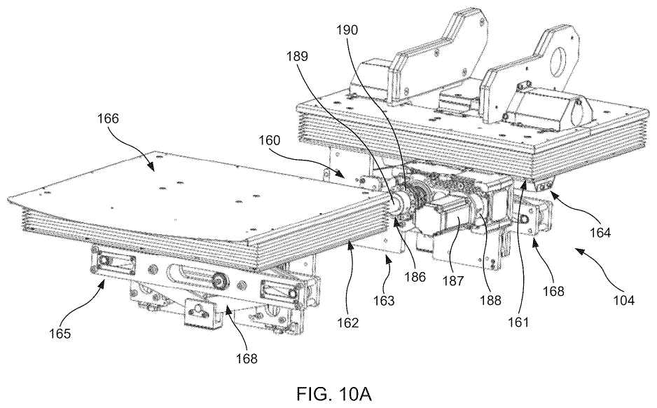

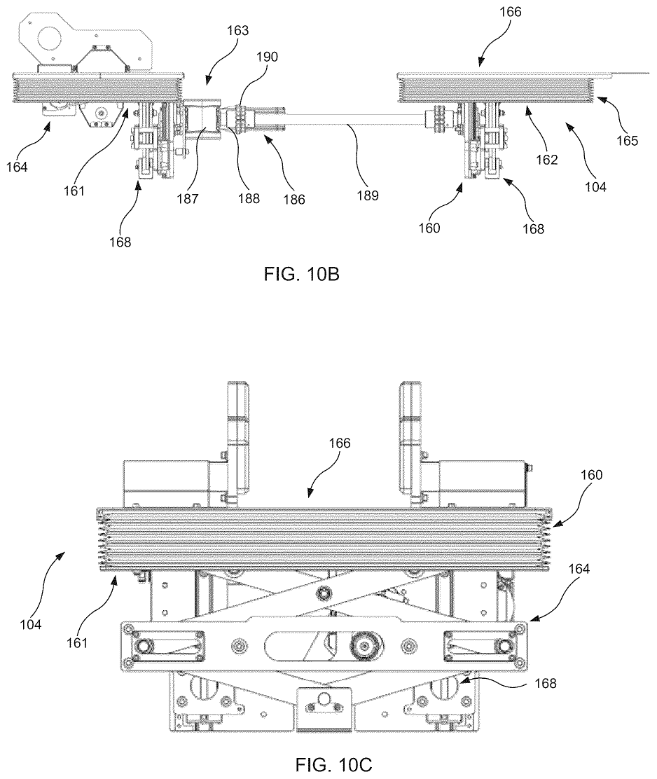

Referring again to FIGS. 1A to 1F in combination with FIGS. 10A to 10C, as discussed, the mobile assembly 100 comprises the lifting assembly 104 mounted on the platform 108. The lifting assembly 104 is configured to provide vertical positioning of a workpiece secured by the clamping assembly 102. The lifting assembly 104 comprises components that enable controlled vertical displacement of a workpiece between a lower position and an upper position, with the range of vertical displacement being sufficient to position the workpiece at various heights required for different stages of assembly operations. The lifting assembly 104 of the present disclosure is particularly suited for applications requiring a compact retracted height while achieving substantial vertical extension for efficiently performing material handling operations, assembly processes, and other industrial tasks.

The lifting assembly 104 of the present disclosure is a modular platform for achieving vertical positioning through mechanical integration of cam-actuated scissor mechanisms with guidance systems. The lifting assembly 104 comprises at least one lifting platform comprising a scissor mechanism actuated by a cam mechanism and guided by linear motion guide rails. This configuration enables control of vertical movement while maintaining minimal retracted height, with the scissor mechanism providing vertical extension capabilities from a compact base profile. The integration of mechanical components including the cam mechanism for actuating the scissor mechanism, and linear motion guide rails for maintaining alignment, enables the lifting assembly 104 to achieve substantial vertical stroke through purely mechanical means with minimal maintenance requirements.

As illustrated, the lifting assembly 104 comprises a base structure 160. The base structure 160 provides a structural foundation for the lifting assembly 104 and is configured to be mounted on the platform 108 of the mobile assembly 100. The base structure 160 serves as the base structural element that supports and aligns all other components of the lifting assembly 104. The base structure 160 is constructed from rigid materials such as steel or aluminium alloy to provide adequate strength and dimensional stability under operational loads. The base structure 160 maintains geometric relationships between components during operation, ensuring consistent performance and preventing mechanical deflection that could affect lifting accuracy. The base structure 160 provides mounting points for components of the lifting assembly 104 and maintains alignment of the components during lifting operations. The base structure 160 is formed as a rigid structure capable of supporting the weight of the lifting assembly 104 and any workpiece positioned thereon without deformation that would affect alignment or operation of the lifting assembly 104.

The base structure 160 provides a rigid mounting foundation and maintains alignment of components during operation across various loading conditions and operational environments. The base structure 160 incorporates mounting regions configured according to application requirements, enabling implementation of single or multiple lifting platforms as needed for specific operational requirements. The structural design of the base structure 160 includes reinforcement features such as ribs, gussets, or cross-bracing to ensure adequate stiffness and prevent deformation under maximum design loads. The base structure 160 is designed to interface with various mounting systems including bolted connections, welded attachments, or integrated mounting features depending on the specific application requirements. The modular design of the base structure 160 enables adaptation to different platform configurations while maintaining structural integrity and operational performance.

In the present configuration, as illustrated in FIGS. 10A to 10C, the lifting assembly 104 has the base structure 160 which is configured to be securely fixed, for example by bolting, to the platform 108 of the mobile assembly 100. The base structure 160 includes a first end portion 161 for supporting the components of a first lifting platform 164 and a second end portion 162 for supporting the components of a second lifting platform 165. The first end portion 161 and the second end portion 162 provide the necessary structural support for the scissor mechanisms extending from the central attachment point. The first end portion 161 and the second end portion 162 may incorporate features such as mounting bosses, alignment pins, and similar structures to ensure accurate positioning of lifting platform components. The base structure 160 further includes a central region 163 positioned between the first end portion 161 and the second end portion 162, configured for housing a drive assembly 186. The central region 163 provides a protected housing for drive components while maintaining accessibility for maintenance and service operations.

The lifting assembly 104 comprises at least one lifting platform arranged on the base structure 160. In the illustrated embodiments, the lifting assembly 104 comprises the first lifting platform 164 and the second lifting platform 165 mounted on the first end portion 161 and the second end portion 162 of the base structure 160, respectively. The first lifting platform 164 and the second lifting platform 165 are designed to operate in a synchronized fashion driven by the common drive assembly 186 housed in the central region 163. The first lifting platform 164 and the second lifting platform 165 each incorporate mechanical components including scissor mechanisms, guidance systems, and actuation mechanisms that are anchored to the base structure 160 to provide vertical positioning capabilities. The first lifting platform 164 and the second lifting platform 165 are designed to support various load types requiring vertical positioning during automated operations.

The at least one lifting platform, including the first lifting platform 164 and the second lifting platform 165, comprises a scissor mechanism 168 having a lower end pivotally mounted to the base structure 160 and an upper end supporting a platform surface 166. The scissor mechanism 168 is the motion-generating component of each lifting platform, providing the fundamental capability for vertical extension and retraction. The scissor mechanism 168 incorporates a mechanical linkage system that converts actuation force into controlled vertical movement while maintaining platform stability throughout the operational range. The lower end of the scissor mechanism 168 is pivotally mounted to the base structure 160 through pivot connections that allow rotational movement while maintaining structural integrity under operational loads. The upper end of the scissor mechanism 168 supports the platform surface 166 that provides the load-bearing interface for supported objects, materials, or assemblies.

As used herein, “scissor mechanism” refers to a linkage system comprising crossed link plates connected by pivot joints that provides vertical extension and retraction motion when actuated. The scissor mechanism 168 is configured to move between a fully retracted position, wherein the platform surface 166 is at a minimum height above the base structure 160, and a fully extended position, wherein the platform surface 166 is at a maximum height above the base structure 160. The scissor mechanism 168 provides a vertical stroke defined as the difference in height of the platform surface 166 between the fully retracted position and the fully extended position.

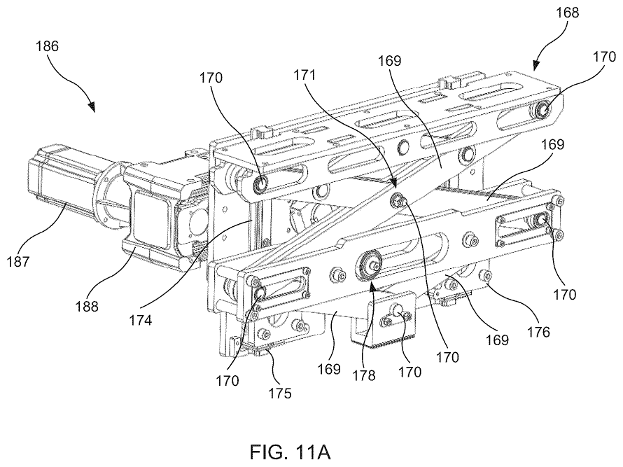

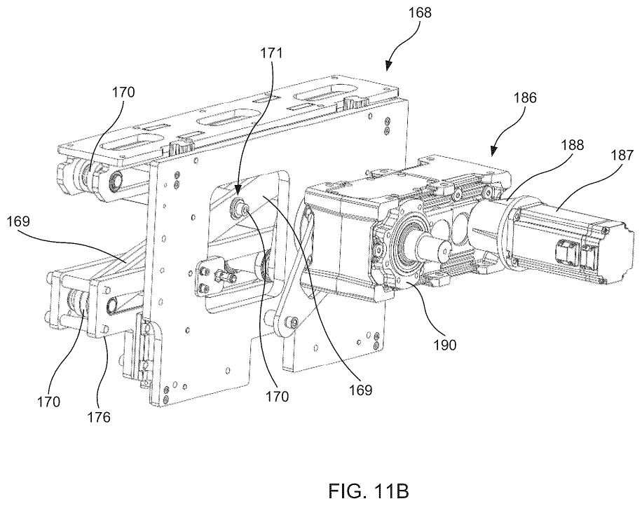

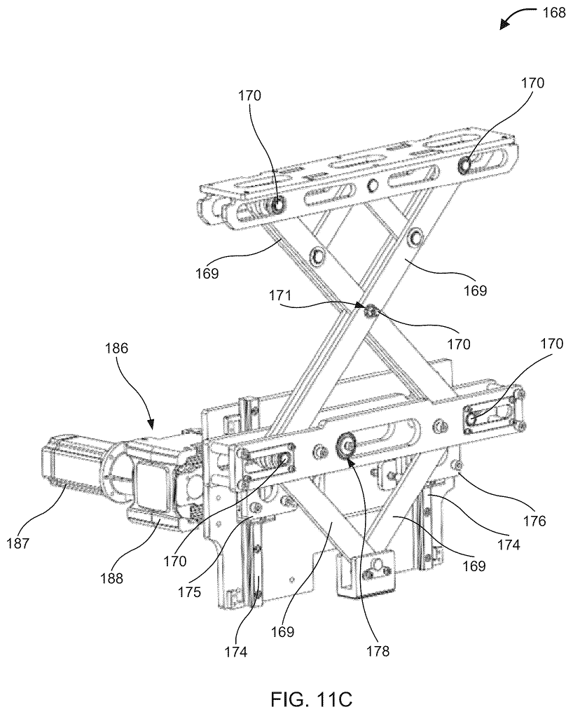

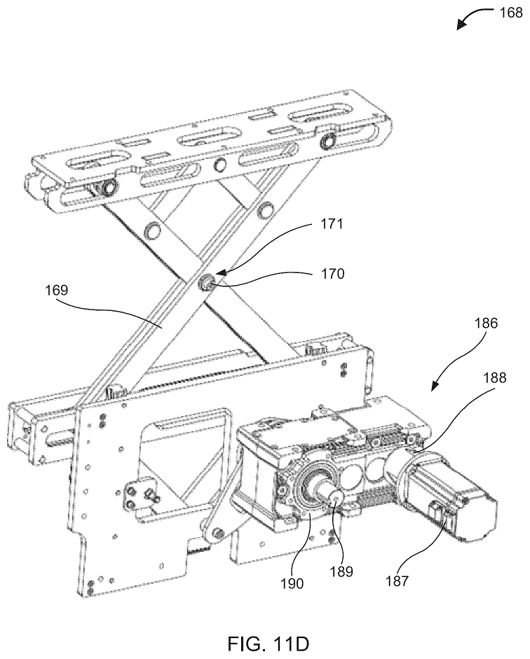

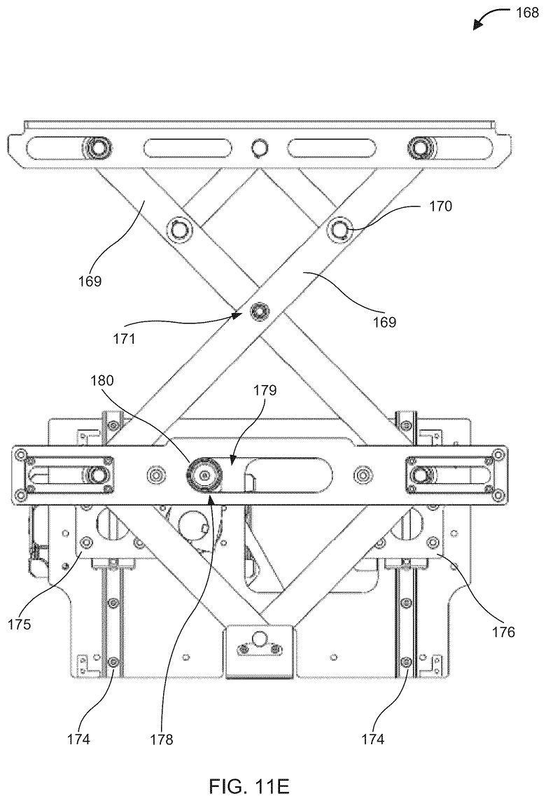

Referring to FIGS. 11A to 11E in combination, illustrated are different views of the scissor mechanism 168 as per embodiments of the present disclosure. As illustrated in FIGS. 11A through 11E, the scissor mechanism 168 comprises a plurality of link plates 169 arranged in a crossed configuration. The plurality of link plates 169 are constructed from high-strength materials such as steel or aluminium alloy to provide adequate load capacity while minimizing weight. Each of the plurality of link plates 169 is manufactured to ensure proper dimensional tolerances and surface finish for smooth operation. The crossed configuration of the plurality of link plates 169 provides the fundamental mechanical advantage that enables vertical extension from a compact retracted position. The intersection points where the plurality of link plates 169 cross are reinforced to handle the concentrated loads and moments generated during lifting operations.

The scissor mechanism 168 also comprises a plurality of pivot joints 170 connecting the plurality of link plates 169 at intersection points. The plurality of pivot joints 170 provide the rotational capability necessary for scissor mechanism 168 operation. Each of the plurality of pivot joints 170 is designed to accommodate the rotational movement between the plurality of link plates 169 while maintaining alignment and minimizing wear. The plurality of pivot joints 170 incorporate features such as bushings, bearings, or other low-friction interfaces to ensure precise operation throughout the operational life of the lifting assembly 104. The spacing and positioning of the plurality of pivot joints 170 are optimized to provide the desired stroke length while maintaining mechanical advantage throughout the range of motion. The design of the plurality of pivot joints 170 ensures adequate strength to handle operational loads while providing the rotational freedom necessary for extension and retraction cycles.

The scissor mechanism 168 further comprises a plurality of bearing assemblies 171 mounted at the plurality of pivot joints 170 to facilitate rotational movement between the plurality of link plates 169 during extension and retraction of the scissor mechanism 168. The plurality of bearing assemblies 171 enable low-friction operation of the scissor mechanism 168 while handling both radial and thrust loads encountered during lifting operations. Each of the plurality of bearing assemblies 171 is selected and designed to provide adequate load capacity for the specific application while maintaining rotational movement throughout the operational life of the lifting assembly 104. The plurality of bearing assemblies 171 may also incorporate sealing features to prevent contamination from operational environments and may include lubrication systems to ensure long-term operational reliability. The plurality of bearing assemblies 171 are positioned at each of the plurality of pivot joints 170 to distribute loads evenly and prevent stress concentrations that could lead to premature wear or failure.

Such configuration of the plurality of link plates 169 and the plurality of pivot joints 170 enables the scissor mechanism 168 to provide a vertical stroke when actuated from the fully retracted position to the fully extended position, while maintaining the platform surface 166 parallel to the base structure 160 through guidance systems. In typical embodiments, the scissor mechanism 168 provides a vertical stroke of at least double the height of the fully retracted position and is capable of extending further as per the requirement of the mobile assembly 100. The stroke length is determined by the geometric configuration of the plurality of link plates 169, the spacing of the plurality of pivot joints 170, and the overall dimensional constraints of the application. The scissor mechanism 168 is designed to maintain consistent mechanical advantage throughout the stroke range, ensuring accurate operation and adequate force transmission from the actuation system to the supported load. The parallel maintenance of the platform surface 166 relative to the base structure 160 is achieved through the geometric relationships built into the scissor mechanism 168 design and the guidance systems that constrain motion to purely vertical translation.

The lifting assembly 104 further comprises at least one linear motion (LM) guide rail 174 arranged vertically on the base structure 160 to provide guidance for vertical movement of the scissor mechanism 168. The at least one LM guide rail 174 serves as a guidance system that ensures accurate vertical movement while preventing lateral displacement, rotation, or tilting of the lifting platform during operation. The at least one LM guide rail 174 provides a guiding surface for the associated guide blocks that move along the rail during lifting operations. The vertical arrangement of the at least one LM guide rail 174 on the base structure 160 ensures that guidance is provided throughout the full range of vertical movement. The at least one LM guide rail 174 is typically constructed from hardened steel or other wear-resistant materials to provide long operational life under repeated loading cycles. The mounting of the at least one LM guide rail 174 to the base structure 160 incorporates alignment features to ensure accurate positioning and maintain guidance accuracy throughout the operational life of the lifting assembly 104.

The at least one LM guide rail 174 ensures vertical alignment throughout the range of motion while preventing lateral movement or twisting of the scissor mechanism 168 during extension and retraction operations. The guidance provided by the at least one LM guide rail 174 helps in maintaining proper platform orientation and ensuring controlled movement under various loading conditions. The at least one LM guide rail 174 incorporates features such as linear bearing races, or other guidance interfaces that provide low-friction, accurate motion control. The design of the at least one LM guide rail 174 may incorporate multiple guidance surfaces or features to constrain movement in multiple directions simultaneously, ensuring that only pure vertical translation occurs during lifting operations. The at least one LM guide rail 174 is designed to handle the various loads and moments generated during lifting operations while maintaining guidance accuracy and preventing wear or damage to guidance surfaces.

The lifting assembly 104 further comprises at least one LM guide block mounted to a central portion of the scissor mechanism 168, wherein the at least one LM guide block engages with the at least one LM guide rail 174 to maintain vertical alignment during lifting operation. The at least one LM guide block interfaces with the at least one LM guide rail 174 to provide controlled motion along the vertical axis while constraining movement in other directions. The at least one LM guide block incorporates bearing elements, sliding surfaces, or other low-friction interfaces that enable movement along the at least one LM guide rail 174 while handling operational loads. The mounting of the at least one LM guide block to the central portion of the scissor mechanism 168 ensures that guidance forces are applied at optimal locations to maintain platform stability and prevent binding or misalignment during operation. The design of the at least one LM guide block incorporates features such as sealing, lubrication, or wear-resistant materials to ensure reliable operation throughout the operational life of the lifting assembly 104.

In the illustrated embodiment, as shown in FIGS. 11A to 11E, each of the first lifting platform 164 and the second lifting platform 165 comprises a first linear motion guide block 175 and a second linear motion guide block 176, both mounted to a central portion, such as a middle lifting plate, of the scissor mechanism 168. The first linear motion guide block 175 and the second linear motion guide block 176 are vertically spaced apart on the central portion and engage with the at least one LM guide rail 174 to maintain vertical alignment during lifting operation. The use of the first linear motion guide block 175 and the second linear motion guide block 176 provides enhanced stability and load distribution compared to single-point guidance systems. By fixing both guide blocks 175, 176 to the central portion of the scissor mechanism 168, the system ensures that the central lifting structure remains perfectly vertical during the stroke. This dual-guide block configuration ensures that the movement of the scissor mechanism 168 is constrained to the vertical axis, thereby maintaining the platform surface 166 parallel to the base structure 160 throughout the entire lifting stroke while providing adequate load capacity and guidance accuracy for various operational requirements.

The lifting assembly 104 further comprises a cam mechanism 178 to actuate the scissor mechanism 168. The cam mechanism 178 serves as the primary actuation system that converts rotational motion from the drive assembly 186 into linear motion that actuates the scissor mechanism 168 for vertical positioning. The cam mechanism 178 provides a mechanical advantage that enables efficient force transmission from the drive system to the scissor mechanism 168 while providing precise position control throughout the lifting stroke. The cam mechanism 178 is designed to provide controlled actuation with optimized force characteristics that match the load requirements of the scissor mechanism 168 throughout its range of motion.

Herein, as illustrated, the cam mechanism 178 comprises a rotatable cam 179 and at least one cam follower 180. The at least one cam follower 180 engages with the rotatable cam 179 and is coupled to a central portion of the scissor mechanism 168. The rotatable cam 179 incorporates a cam profile designed to provide the desired motion characteristics for actuation of the scissor mechanism 168. The cam profile is designed to provide optimal force transmission and motion control throughout the lifting stroke, with consideration for factors such as mechanical advantage, acceleration profiles, and load distribution. The rotatable cam 179 is mounted on a shaft or axis that allows rotation while maintaining precise positioning relative to the at least one cam follower 180 and the scissor mechanism 168. The design of the rotatable cam 179 may incorporate features such as bearings, sealing, or lubrication systems to ensure smooth operation and long operational life. Rotation of the rotatable cam 179 causes movement of the at least one cam follower 180, which in turn causes extension or retraction of the scissor mechanism 168 depending on the direction of rotation of the rotatable cam 179.

The at least one cam follower 180 engages with the rotatable cam 179 and provides the interface between the rotatable cam 179 and the linear motion required for scissor mechanism 168 actuation. The at least one cam follower 180 is designed to maintain continuous contact with the cam surface while accommodating the varying forces and motion profiles encountered during lifting operations. The at least one cam follower 180 may incorporate features such as roller bearings, sliding surfaces, or other low-friction interfaces that enable motion while minimizing wear and maintaining accuracy. The coupling of the at least one cam follower 180 to the central portion of the scissor mechanism 168 ensures that actuation forces are applied at optimal locations to provide efficient and controlled motion of the lifting platform. For present purposes, the design of the at least one cam follower 180 incorporates adequate load capacity and wear resistance to ensure reliable operation throughout the operational life of the lifting assembly 104.

Referring again to FIGS. 10A to 10C, the lifting assembly 104 comprises the drive assembly 186 configured to operate the cam mechanism 178 and provide the motive power for lifting operations. The drive assembly 186 serves as the primary power source that converts electrical energy into mechanical motion for actuating the cam mechanisms and lifting platforms. The drive assembly 186 is designed to provide adequate power and torque to handle the maximum design loads while maintaining precise speed and position control throughout the lifting stroke. The drive assembly 186 incorporates components such as motors, gearboxes, and power transmission elements that work together to provide reliable and efficient operation under various loading conditions and operational requirements. The design of the drive assembly 186 considers factors such as power requirements, speed control, position accuracy, and operational environment to ensure reliable performance throughout the operational life of the lifting assembly 104. The drive assembly 186 is configured to rotate the cam mechanism 178 to move the scissor mechanism 168 between the fully retracted position and the fully extended position.

As illustrated in FIGS. 10A to 10C, the drive assembly 186 comprises a motor 187 and a gearbox 188 coupled to the motor 187 to provide the necessary torque and speed characteristics for lifting operations. The motor 187 is selected to provide adequate power for the maximum design loads while incorporating features such as variable speed control, position feedback, and braking capability as required for the specific application. The motor 187 may be an electric motor such as a servo motor, stepper motor, or variable frequency drive motor, depending on the specific control and performance requirements of the application. The motor 187 incorporates electrical connections and control interfaces that enable integration with the overall control system of the lifting assembly 104 or associated equipment. The design of the motor 187 considers factors such as environmental conditions, mounting requirements, and maintenance accessibility to ensure reliable operation in the intended application environment.

The gearbox 188 coupled to the motor 187 provides speed reduction and torque amplification to match the motor 187 characteristics with the requirements of the lifting assembly 104. The gearbox 188 is selected to provide the appropriate speed reduction ratio that enables the motor 187 to operate at optimal efficiency while providing the torque and speed characteristics required for lifting operations. The gearbox 188 may incorporate various gear types such as spur gears, helical gears, or planetary gears depending on the specific requirements for compactness, efficiency, and load capacity. The design of the gearbox 188 incorporates adequate strength to handle operational loads while maintaining accurate motion transmission and minimal backlash for precise position control. The gearbox 188 may incorporate features such as lubrication systems, sealing, or mounting interfaces that facilitate installation, operation, and maintenance of the drive assembly 186.

In present embodiments where the lifting assembly 104 comprises the first lifting platform 164 and the second lifting platform 165, the drive assembly 186 further comprises a drive shaft 189 coupled to the gearbox 188 and connecting cam mechanisms of the first lifting platform 164 and the second lifting platform 165, wherein rotation of the drive shaft 189 causes synchronized rotation of rotatable cams 179 to actuate scissor mechanisms 168 of both lifting platforms. This configuration enables synchronized operation of the first lifting platform 164 and the second lifting platform 165, ensuring that loads are lifted in a coordinated manner that maintains stability and prevents binding or misalignment during operation. The drive shaft 189 provides mechanical coupling between the cam mechanisms of different lifting platforms, ensuring that all platforms move together with synchronization regardless of load variations or minor differences in component tolerances. The synchronized operation is particularly important for applications where loads must be maintained level during lifting or where multiple lifting points are required to handle large or awkwardly shaped objects. The drive assembly 186 is operatively coupled to both the first lifting platform 164 and the second lifting platform 165 to provide synchronized vertical movement.

The drive shaft 189 comprises a first end portion coupled to the cam mechanism 178 of the first lifting platform 164, a second end portion coupled to the cam mechanism 178 of the second lifting platform 165, and a coupling assembly 190 connecting the gearbox 188 to the drive shaft 189 for transferring rotational motion from the motor 187. The first end portion and the second end portion of the drive shaft 189 provide mechanical coupling interfaces that connect to the rotatable cams 179 of the respective lifting platforms, ensuring that rotation of the drive shaft 189 directly controls the position of both cam mechanisms. The drive shaft 189 is constructed from materials that provide adequate torsional strength and dimensional stability to maintain synchronization accuracy under operational loads. The design of the drive shaft 189 may incorporate features such as universal joints, flexible couplings, or other elements that accommodate minor misalignments while maintaining positive mechanical coupling between lifting platforms.

The coupling assembly 190 connecting the gearbox 188 to the drive shaft 189 provides a flexible and efficient means of transferring rotational motion from the motor 187 while accommodating minor misalignments and providing some degree of shock absorption during operation. The coupling assembly 190 enables easy disconnection for maintenance operations while providing positive mechanical coupling during normal operation. In present examples, the coupling assembly 190 may be in the form of a jaw coupling, a friction coupling, a solid coupling, or the like, as per requirements of the mobile assembly 100. The coupling assembly 190 may incorporate features such as chain lock, alignment guides, or protective guards that ensure reliable operation while facilitating maintenance and service operations. The coupling assembly 190 also provides some degree of mechanical isolation between the drive motor 187 and the lifting mechanisms, reducing the transmission of vibrations or shock loads that could affect motor 187 performance or operational accuracy.

In some embodiments, the motor 187 incorporates an encoder for monitoring angular position of a motor shaft, a drive controller for synchronized operation of the first lifting platform 164 and the second lifting platform 165, and a braking mechanism for maintaining the lifting platforms at intermediate positions between the fully retracted position and the fully extended position. These integrated control features enable accurate position control and reliable operation of the lifting assembly 104 under various operational conditions and requirements. The combination of position feedback, motion control, and position holding capability provides the accuracy and reliability required for automated applications. The integration of these features into the motor 187 assembly simplifies system design and reduces the complexity of external control systems while ensuring reliable operation throughout the operational life of the lifting assembly 104.

In particular, the encoder for monitoring angular position of the motor shaft provides feedback regarding the rotational position of the motor 187, which directly corresponds to the position of the first lifting platform 164 and the second lifting platform 165 through the mechanical coupling of the drive system. The encoder may be an incremental encoder that provides position feedback based on rotational increments, or an absolute encoder that provides direct position information regardless of power cycling or initialization sequences. The encoder provides electrical signals that are processed by the drive controller to determine exact platform position and enable position control throughout the lifting stroke. The encoder resolution is selected to provide adequate position accuracy for the specific application requirements while considering factors such as mechanical backlash, system compliance, and operational tolerances.

The drive controller for synchronized operation of the first lifting platform 164 and the second lifting platform 165 processes feedback from the encoder and other system inputs to provide motion control and maintain synchronization between multiple lifting platforms, when the lifting platforms are driven independently using multiple drive systems. The drive controller incorporates digital signal processing capabilities that enable complex motion profiles, acceleration control, and position accuracy while accommodating various operational requirements and load conditions. The drive controller interfaces with external control systems to receive operational commands and provide status feedback, enabling integration with larger automated systems or manual control interfaces. The drive controller incorporates safety features such as limit detection, fault monitoring, and emergency stop capability to ensure safe operation under various conditions including component failures or operational errors.

The braking mechanism for maintaining the first lifting platform 164 and the second lifting platform 165 at intermediate positions between the fully retracted position and the fully extended position provides secure position holding capability that prevents uncontrolled movement when the lifting assembly 104 is not actively powered or when holding position against external loads. The braking mechanism may be an electromagnetic brake, friction brake, or other type of braking system that provides adequate holding force for the maximum design loads while enabling quick release for normal operation. The braking mechanism is designed to engage automatically when power is removed or when commanded by the control system, ensuring safe operation under various conditions including power failures or emergency situations. The braking mechanism incorporates adequate capacity to maintain position under maximum design loads while providing rapid engagement and release for efficient operation.

The configuration of the lifting assembly 104 with the scissor mechanism 168 and the cam mechanism 178 enables the lifting assembly 104 to achieve substantial vertical stroke while maintaining a compact height in the fully retracted position. The cam mechanism 178 converts rotational motion from the drive assembly 186 into linear motion that actuates the scissor mechanism 168, with the cam profile designed to provide efficient force transmission throughout the range of vertical travel. The at least one LM guide rail 174 ensures that the scissor mechanism 168 moves vertically without lateral deviation, maintaining the platform surface 166 parallel to the base structure 160 throughout vertical displacement. The scissor mechanism 168, when actuated from the fully retracted position to the fully extended position through rotation of the cam mechanism 178, provides a vertical stroke while maintaining the platform surface 166 parallel to the base structure 160 through guidance of the at least one LM guide rail 174.

In operation of the lifting assembly 104, when a lifting sequence is initiated, the motor 187 drives the drive shaft 189 through the gearbox 188 and the coupling assembly 190. The rotation of the drive shaft 189 causes synchronized movement of the cam mechanisms 178 in the first lifting platform 164 and the second lifting platform 165. As each rotatable cam 179 moves through the defined angular range, the respective cam follower 180 translates the rotational motion into vertical movement of the central portion of the scissor mechanism 168. The at least one LM guide rail 174 maintains vertical alignment throughout this motion, preventing any lateral movement or misalignment of the platform surfaces 166. This operational sequence demonstrates the coordinated interaction of all system components to provide reliable vertical positioning capability.

During the lifting operation, the first linear motion guide block 175 and the second linear motion guide block 176 travel together with the central portion of the scissor mechanism 168 along the respective linear motion guide rails 174. This guided movement ensures that the first lifting platform 164 and the second lifting platform 165 maintain parallel alignment with the base structure 160 by preventing lateral shifting or tilting of the scissor mechanism 168. The plurality of bearing assemblies 171 at each of the plurality of pivot joints 170 facilitate smooth rotational movement between the plurality of link plates 169 as the scissor mechanisms 168 extend or retract. The synchronized operation of the first lifting platform 164 and the second lifting platform 165 through the common drive shaft 189 ensures balanced lifting motion and maintains stability of the supported load throughout the vertical stroke range. The coordinated operation of the guidance system, actuation system, and structural components ensures accurate vertical positioning while maintaining load stability and system reliability throughout the operational cycle.

Referring now to FIG. 12, illustrated is a schematic block diagram of a mobile assembly system 200, in accordance with one or more embodiments of the present disclosure. The mobile assembly system 200 comprises the platform 108, the clamping assembly 102 mounted on the platform 108, the lifting assembly 104 mounted on the platform 108, and a controller 201 operatively coupled to the clamping assembly 102 and the lifting assembly 104. The mobile assembly system 200 incorporates the components of the mobile assembly 100 described above with the addition of the controller 201 that provides coordinated control of the clamping assembly 102 and the lifting assembly 104.

The controller 201 is operatively coupled to the clamping assembly 102 and the lifting assembly 104 to coordinate operation of both assemblies for workpiece handling. As used herein, “operatively coupled” refers to the controller 201 being connected to the clamping assembly 102 and the lifting assembly 104 through electrical or electronic connections that enable the controller 201 to receive signals from sensors of the assemblies and to transmit control signals to motors and other actuators of the assemblies. The operative coupling enables the controller 201 to monitor parameters of the clamping assembly 102 and the lifting assembly 104 and to control operation of both assemblies based on the monitored parameters.

The controller 201 comprises a processor 202 and a memory 204. The processor 202 is configured to execute instructions stored in the memory 204 to perform control functions for the clamping assembly 102 and the lifting assembly 104. The memory 204 stores instructions, parameters, threshold values, and other data used by the processor 202 for controlling operation of the mobile assembly system 200. The controller 201 may comprise a microcontroller, programmable logic controller (PLC), industrial computer, or other computing device suitable for industrial control applications.

The controller 201 comprises a sensor input module 206 configured to receive signals from sensors of the clamping assembly 102 and the lifting assembly 104. The sensor input module 206 receives signals from the at least one sensor 146 of the clamping assembly 102, including a current sensor providing data indicative of the clamping force applied by the first movable plate 112 and the second movable plate 114, and one or more position sensors (such as, encoders) providing data indicative of positions of the first movable plate 112 and the second movable plate 114. The sensor input module 206 further receives signals from position sensors 192 of the lifting assembly 104, providing data indicative of the vertical position of the platform surface 166.

For purposes of the present disclosure, the controller 201 comprises a motor control module 208 configured to generate control signals for motors of the clamping assembly 102 and the lifting assembly 104. The motor control module 208 generates control signals for the motor 136 of the clamping assembly 102 to control movement of the first movable plate 112 and the second movable plate 114. The motor control module 208 further generates control signals for the motor of the drive assembly 186 of the lifting assembly 104 to control vertical positioning of the platform surface 166.

The controller 201 is configured to verify successful clamping provided by the clamping assembly 102 before initiating vertical displacement via the lifting assembly 104. The controller 201 monitors both the clamping force parameter received from the at least one sensor 146 and position data of the first movable plate 112 and the second movable plate 114. The controller 201 compares the clamping force parameter to a predetermined threshold value and verifies that the position data falls within a predetermined position range. The controller 201 permits operation of the lifting assembly 104 only when both the clamping force parameter meets or exceeds the predetermined threshold value and the position data is within the predetermined position range. This dual verification ensures that the high clamping force is a result of engaging the workpiece rather than a mechanical jam or obstruction, thereby preventing false detection of successful clamping and ensuring the workpiece is securely clamped before the lifting assembly 104 initiates vertical displacement.

As used herein, “predetermined threshold value” refers to a stored value representing a minimum clamping force required to securely hold a workpiece, and “predetermined position range” refers to a range of coordinate values corresponding to expected dimensions of the workpiece to be handled. The predetermined threshold value and the predetermined position range may be set based on characteristics of workpieces to be handled, including weight, surface characteristics, and dimensional tolerances. In some embodiments, the memory 204 stores multiple predetermined threshold values and corresponding predetermined position ranges for different workpiece types, and the controller 201 selects appropriate parameters based on identification of the workpiece to be handled. This configuration enables the mobile assembly 100 to autonomously adapt its verification logic as it moves between different stations handling varying workpiece types.

The controller 201 is further configured to maintain the clamping force during vertical displacement operations. The controller 201 continues to monitor the clamping force parameter and the position data during operation of the lifting assembly 104, and controls the motor 136 of the clamping assembly 102 to maintain the clamping force at or above the predetermined threshold value throughout the vertical displacement operation. If the clamping force parameter drops below the predetermined threshold value or if the position data indicates unexpected plate movement during vertical displacement, the controller 201 may increase the clamping force by operating the motor 136 of the clamping assembly 102 to move the first movable plate 112 and the second movable plate 114 further toward each other, or the controller 201 may halt operation of the lifting assembly 104 until the clamping force is restored and the position is verified.

The controller 201 is further configured to prevent the lifting assembly 104 from initiating vertical displacement until successful clamping is confirmed by both the force and position parameters. In some embodiments, the controller 201 may implement an interlock function that disables operation of the lifting assembly 104 when either the clamping force parameter is below the predetermined threshold value or the position data is outside the predetermined position range. This interlock function prevents inadvertent lifting of a workpiece that is not securely clamped or is falsely detected due to an obstruction, protecting against workpiece slippage or falling during lifting operations.

In some embodiments, the controller 201 is further configured to receive dimensional data associated with a workpiece, adjust the clamping assembly 102 based on the dimensional data, and control vertical positioning of the workpiece via the lifting assembly 104 based on assembly operation requirements. The controller 201 may receive dimensional data from external systems, such as a manufacturing execution system or barcode/RFID identification system, that provides information about the workpiece to be handled. Based on the dimensional data, the controller 201 adjusts operation of the clamping assembly 102 to position the first movable plate 112 and the second movable plate 114 at appropriate starting positions, sets the predetermined position range for verification, and adjusts operation of the lifting assembly 104 to position the workpiece at heights required for specific assembly operations. This data-driven adaptability enhances the modularity of the mobile assembly 100, allowing it to integrate into automated workflows.

In some embodiments, the controller 201 is further configured to continuously monitor the clamping force parameter and a clamping position parameter from the clamping assembly 102, as well as a vertical position parameter from the lifting assembly 104 during operations, and halt operations of both the clamping assembly 102 and the lifting assembly 104 upon detecting an anomaly in any of the clamping force parameter, the clamping position parameter, or the vertical position parameter. As used herein, “anomaly” refers to a deviation from expected parameter values during operation, including unexpected changes in clamping force, clamping plate position, or vertical position that may indicate a problem with workpiece holding or positioning. Detection of an anomaly causes the controller 201 to halt operations of both assemblies to prevent damage to the workpiece or equipment, or injury to personnel.

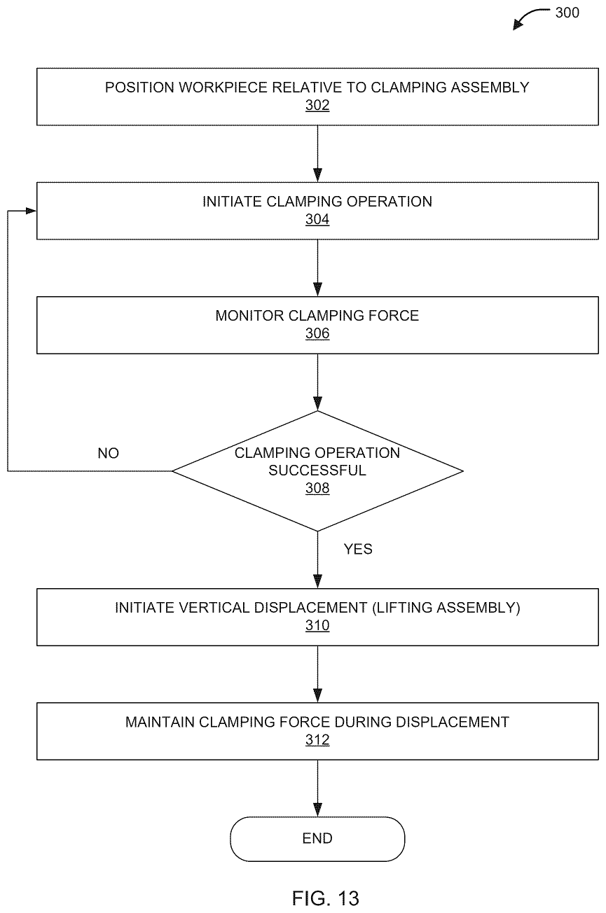

Referring to FIG. 13, illustrated is a flowchart of a method 300 for operating the mobile assembly system 200, in accordance with one or more embodiments of the present disclosure. The controller 201 is configured to execute a sequential operation protocol comprising the steps of the method 300. The sequential operation protocol ensures that operations of the clamping assembly 102 and the lifting assembly 104 are performed in a defined sequence that maintains workpiece security throughout assembly processes.

At step 302, the method 300 involves positioning a workpiece relative to the clamping assembly 102. A workpiece is placed on the platform surface 166 of the lifting assembly 104 within the clamping region between the first movable plate 112 and the second movable plate 114 of the clamping assembly 102. The positioning may be performed manually by an operator, by another automated system, or by movement of the mobile assembly 100 to a position where a workpiece is to be loaded. In embodiments comprising the first lifting platform 164 and the second lifting platform 165, the workpiece may be positioned such that different portions of the workpiece are supported by respective platform surfaces 166 of the first lifting platform 164 and the second lifting platform 165.

At step 304, the method 300 involves initiating a clamping operation via the clamping assembly 102. The controller 201 generates control signals for the motor 136 of the clamping assembly 102 to rotate the lead screw shaft 122, causing the first movable plate 112 and the second movable plate 114 to move toward each other in a synchronized manner. The first movable plate 112 and the second movable plate 114 engage the workpiece, with the self-centering characteristic of the drive mechanism 120 automatically centering the workpiece within the clamping region.

At step 306, the method 300 involves monitoring clamping force during the clamping operation. The controller 201 receives signals from the at least one sensor 146 indicative of the clamping force applied by the first movable plate 112 and the second movable plate 114. The controller 201 monitors the clamping force as the first movable plate 112 and the second movable plate 114 continue to move toward each other and engage the workpiece.

At step 308, the method 300 involves verifying that clamping operation is successful, i.e., the clamping force has reached a predetermined threshold and the clamping assembly 102 is within a predetermined position range. The controller 201 compares the monitored clamping force to the predetermined threshold value stored in the memory 204 and compares the current position of the movable plates 112, 114 to a stored position range. If the clamping force has reached the predetermined threshold value and the position is within the stored position range, the controller 201 proceeds to step 310. If the clamping force has not reached the predetermined threshold value If either condition is not met, the controller 201 continues the clamping operation at step 304 or generates an alert indicating a clamping fault.

At step 310, the method 300 involves initiating vertical displacement via the lifting assembly 104 only upon successful verification. The controller 201 generates control signals for the motor 187 of the drive assembly 186 to rotate the rotatable cam 179 of the cam mechanism 178, causing the scissor mechanism 168 to extend and raise the platform surface 166. The rotation of the rotatable cam 179 engages the cam follower 180 coupled to the central portion of the scissor mechanism 168, causing the plurality of link plates 169 to pivot at the plurality of pivot joints 170 and thereby extend the scissor mechanism 168. The at least one LM guide rail 174 and the LM guide blocks 175, 176, fixed to the central portion, maintain vertical alignment of the scissor mechanism 168 during extension. The workpiece, secured by the clamping assembly 102, is raised along with the platform surface 166 to a target height for assembly operations. In embodiments comprising the first lifting platform 164 and the second lifting platform 165, the drive shaft 189 ensures synchronized rotation of the rotatable cams 179 of both lifting platforms, maintaining the workpiece level throughout vertical displacement.

At step 312, the method 300 involves maintaining the clamping force during vertical displacement. The controller 201 continues to monitor the clamping force parameter during the vertical displacement operation and controls the motor 136 of the clamping assembly 102 to maintain the clamping force at or above the predetermined threshold value. If the clamping force drops below the predetermined threshold value, the controller 201 may halt the vertical displacement operation by stopping the motor 187 of the drive assembly 186 and engaging the braking mechanism to maintain the scissor mechanism 168 at the current position, and restore the clamping force before continuing.

Throughout execution of the method 300, the controller 201 continuously monitors both the clamping operation and the vertical position parameter, and halts operations of both the clamping assembly 102 and the lifting assembly 104 upon detecting an anomaly in either parameter. Upon completion of assembly operations, the method 300 may be executed in reverse, with the motor 187 of the drive assembly 186 rotating the rotatable cam 179 in the opposite direction to retract the scissor mechanism 168 and lower the workpiece to a lower position while the clamping assembly 102 maintains clamping force, followed by release of the clamping force to enable removal of the workpiece.

In one or more embodiments of the present disclosure, the mobile assembly 100 and the mobile assembly system 200 may be implemented in an assembly line for assembly of vehicles, including two-wheeled vehicles such as motorcycles, scooters, and bicycles. In such implementations, the clamping assembly 102 is configured to clamp wheels of the vehicle while the lifting assembly 104 provides vertical positioning of the vehicle for different stages of assembly. The synchronized and self-centering operation of the clamping assembly 102 enables accommodation of different wheel sizes without manual adjustment, while the coordinated control provided by the controller 201 ensures that the vehicle remains securely held throughout assembly operations. The first lifting platform 164 and the second lifting platform 165 may be positioned to support different portions of the vehicle, such as front and rear wheel assemblies, with the synchronized operation through the drive shaft 189 ensuring that the vehicle remains level during vertical displacement.

In one or more embodiments, the mobile assembly 100 may include safety features for operator protection. The at least one proximity sensor 148 of the clamping assembly 102 provides detection of objects within the clearance zone adjacent to the first movable plate 112 and the second movable plate 114, enabling the controller 201 to halt or slow operation of the clamping assembly 102 when an object is detected to prevent pinch-point hazards. Additionally, guards or covers may be provided to prevent access to moving components of the clamping assembly 102 and the lifting assembly 104 during operation. The controller 201 may further incorporate limit detection and fault monitoring for the lifting assembly 104, including monitoring of the encoder feedback from the motor 187 to detect unexpected movements or positions of the scissor mechanism 168.

In one or more embodiments, the mobile assembly 100 may comprise a single lifting platform rather than the first lifting platform 164 and the second lifting platform 165. In such embodiments, a single scissor mechanism 168 and cam mechanism 178 provide vertical positioning, with the clamping assembly 102 positioned to engage workpieces supported by the single lifting platform. The single lifting platform configuration may be suitable for smaller workpieces or applications where a shorter platform length is acceptable. The drive assembly 186 in such embodiments may comprise the motor 187 and gearbox 188 directly coupled to the rotatable cam 179 without the drive shaft 189 and coupling assembly 190 required for synchronized dual-platform configurations.

In one or more embodiments, the mobile assembly system 200 may be integrated with a manufacturing execution system (MES) or other production control system. The controller 201 may communicate with the MES to receive workpiece identification data, assembly operation instructions, and target positions for the clamping assembly 102 and the lifting assembly 104. The controller 201 may further communicate operational status, fault conditions, and production data to the MES for tracking and quality control purposes. The position feedback from the encoder of the motor 187 of the lifting assembly 104 and the position sensor of the clamping assembly 102 may be transmitted to the MES for verification of assembly operations and quality assurance documentation.

The mobile assembly 100 of the present disclosure having the clamping assembly 102 and the lifting assembly 104 facilitates coordinated securing and vertical positioning of a workpiece. The clamping assembly 102 is configured to adapt to different workpiece dimensions while providing controlled clamping force, and the lifting assembly 104 is configured to provide vertical positioning of the workpiece secured by the clamping assembly 102. Further, the mobile assembly system 200 of the present disclosure eliminates manual coordination of handling operations by utilizing the controller 201 to maintain the clamping force during vertical displacement operations. The controller 201 operatively coupled to the clamping assembly 102 and the lifting assembly 104 is configured to verify that the clamping force provided by the clamping assembly 102 reaches a predetermined threshold value before initiating vertical displacement via the lifting assembly 104. The drive mechanism 120 is configured to move the first movable plate 112 and the second movable plate 114 in a synchronized and self-centering manner, allowing the clamping assembly 102 to automatically accommodate varying workpiece dimensions without manual reconfiguration. This configuration ensures that the first movable plate 112 and the second movable plate 114 securely engage the workpiece prior to any vertical movement provided by the lifting assembly 104. Furthermore, the controller 201 continuously monitors both a clamping force parameter from the clamping assembly 102 and a vertical position parameter from the lifting assembly 104 during operations, and is configured to halt operations of both the clamping assembly 102 and the lifting assembly 104 upon detecting an anomaly in either parameter. This continuous monitoring and coordinated control ensures that the workpiece remains securely held throughout the vertical positioning process compared to systems relying on independent operation of clamping and lifting functions.

It may be noted that the foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

1. A mobile assembly comprising:
a platform;
a clamping assembly mounted on the platform, the clamping assembly configured to adapt to different workpiece dimensions while providing controlled clamping force; and
a lifting assembly mounted on the platform, the lifting assembly configured to provide vertical positioning of a workpiece secured by the clamping assembly.

2. The mobile assembly of claim 1, wherein the clamping assembly comprises:
a support frame; and
first and second movable plates mounted on the support frame.

3. The mobile assembly of claim 2, wherein the clamping assembly further comprises a drive mechanism coupled to the first and second movable plates, wherein the drive mechanism is configured to move the first and second movable plates in a synchronized and self-centering manner.

4. The mobile assembly of claim 3, wherein the clamping assembly further comprises:
a guide shaft mounted parallel to a lead screw shaft of the drive mechanism; and
guide elements coupled to the first and second movable plates and slidably engaged with the guide shaft to prevent rotation of the first and second movable plates.

5. The mobile assembly of claim 2, wherein the clamping assembly further comprises:
at least one sensor configured to monitor at least one parameter indicative of the clamping force applied by the first and second movable plates.

6. The mobile assembly of claim 5, wherein the clamping assembly further comprises:
at least one proximity sensor configured to detect presence of an object within a predetermined clearance zone adjacent to the first and second movable plates during movement thereof.

7. The mobile assembly of claim 2, wherein the clamping assembly further comprises:
a motor coupled to the drive mechanism; and
a quick-release mechanism configured to enable transition between powered operation via the motor and manual operation.

8. The mobile assembly of claim 1, wherein the lifting assembly comprises:
a base structure;
at least one lifting platform arranged on the base structure, the at least one lifting platform comprising:
a scissor mechanism having a lower end pivotally mounted to the base structure and an upper end supporting a platform surface; and
at least one linear motion guide rail arranged vertically on the base structure to provide guidance for vertical movement of the scissor mechanism.

9. The mobile assembly of claim 8, wherein the lifting assembly further comprises:
a cam mechanism comprising a rotatable cam and at least one cam follower, wherein the at least one cam follower engages with the rotatable cam and is coupled to a central portion of the scissor mechanism; and
a drive assembly configured to rotate the cam mechanism to move the scissor mechanism between a fully retracted position and a fully extended position.

10. The mobile assembly of claim 9, wherein:
the lifting assembly comprises a first lifting platform and a second lifting platform; and
the drive assembly is operatively coupled to both the first lifting platform and the second lifting platform to provide synchronized vertical movement.

11. A mobile assembly system comprising:
a platform;
a clamping assembly mounted on the platform, the clamping assembly configured to adapt to different workpiece dimensions while providing controlled clamping force;
a lifting assembly mounted on the platform, the lifting assembly configured to provide vertical positioning; and
a controller operatively coupled to the clamping assembly and the lifting assembly, the controller configured to:
verify clamping force provided by the clamping assembly before initiating vertical displacement via the lifting assembly; and
maintain the clamping force during vertical displacement operations.

12. The mobile assembly system of claim 11, wherein the controller is further configured to:
receive dimensional data associated with a workpiece;
adjust the clamping assembly based on the dimensional data; and
control vertical positioning of the workpiece via the lifting assembly based on assembly operation requirements.

13. The mobile assembly system of claim 11, wherein the controller is further configured to:
prevent the lifting assembly from initiating vertical displacement until the clamping force provided by the clamping assembly reaches a predetermined threshold value.

14. The mobile assembly system of claim 11, wherein the controller is further configured to execute a sequential operation protocol comprising:
positioning a workpiece relative to the clamping assembly;
initiating a clamping operation via the clamping assembly;
verifying that the clamping force has reached a predetermined threshold and the clamping assembly is within a predetermined position range; and
initiating vertical displacement via the lifting assembly only upon successful verification.

15. The mobile assembly system of claim 11, wherein the controller is further configured to:
continuously monitor the clamping operation of the clamping assembly and a vertical position parameter from the lifting assembly during operations; and
halt operations of both the clamping assembly and the lifting assembly upon detecting an anomaly therein.
